(19) United States
(12) Patent Application Publication
(10) Pub. No.: US 2010/0073107 A1
(43) Pub. Date: Mar. 25, 2010

(54) MICRO-MINIATURE MONOLITHIC ELECTROMAGNETIC RESONATORS

(75) Inventors: Eric M. Prophet, Santa Barbara, CA (US); Balam A. Willemsen, Newbury Park, CA (US)

Correspondence Address: Vista IP Law Group LLP, 2040 MAIN STREET, 9TH FLOOR, IRVINE, CA, 92614, US

(73) Assignee: SUPERCONDUCTOR TECHNOLOGIES INC., Santa Barbara, CA (US)

(21) Appl. No.: 12/410,976

(22) Filed: Mar. 25, 2009

Related U.S. Application Data
(60) Provisional application No. 61/070,634, filed on Mar. 25, 2008.
(60) Provisional application No. 61/163,167, filed on Mar. 25, 2009.

(51) Int. Cl. H01P 1/203

(52) U.S. Cl. 333/204

(57) ABSTRACT

A filter comprises a substrate, and one or more resonator structures formed on a planar side of the substrate. Each of the one or more resonator structures has a resonant frequency and comprises a folded transmission line that is patterned to form a plurality of adjacent line segments and a plurality of gaps disposed between the adjacent line segments. The ratio of a sum of an average width of the adjacent lines and an average width of the gaps to a thickness of the substrate is equal to or less than 0.50. The filter further comprises an input terminal coupled to one end of the one or more resonator structures, and an output terminal connected to another end of the one or more resonator structures.

### RELATED APPLICATION

This application claims priority from U.S. Provisional Patent Application Ser. Nos. 61/070,634, filed Mar. 25, 2008, and 61/163,167, filed Mar. 25, 2009, which are expressly incorporated herein by reference.

### STATEMENT REGARDING FEDERALLY SPONSORED RESEARCH AND DEVELOPMENT

The U.S. Government may have a paid-up license in this invention and a right in limited circumstances to require the patent owner to license it to others on reasonable terms as provided for by the terms of Contract No. H94003-05-C-0508 awarded by the Defense MicroElectronics Activity (DMEA) established by the Department of Defense.

### FIELD OF THE INVENTION

The present inventions generally relate to microwave filters, and more particularly, to microwave filters designed for narrow-band applications.

### BACKGROUND OF THE INVENTION

Electrical filters have long been used in the processing of electrical signals. In particular, such electrical filters are used to select desired electrical signal frequencies from an input signal by passing the desired signal frequencies, while blocking or attenuating other undesirable electrical signal frequencies. Filters may be classified in some general categories that include low-pass filters, high-pass filters, band-pass filters, and band-stop filters, indicative of the type of frequencies that are selectively passed by the filter. Further, filters can be classified by type, such as Butterworth, Chebyshev, Inverse Chebyshev, and Elliptic, indicative of the type of bandshape frequency response (frequency cutoff characteristics) the filter provides relative to the ideal frequency response.

The type of filter used often depends upon the intended use. In communications applications, band-pass filters are conventionally used in cellular base stations and other telecommunications equipment to filter out or block RF signals in all but one or more predefined bands. For example, such filters are typically used in a receiver front-end to filter out noise and other unwanted signals that would harm components of the receiver in the base station or telecommunications equipment. Placing a sharply defined band-pass filter directly at the receiver antenna input will often eliminate various adverse effects resulting from strong interfering signals at frequencies near the desired signal frequency. Because of the location of the filter at the receiver antenna input, the insertion loss must be very low so as to not degrade the sensitivity of the receiver as measured by its noise figure. In most filter technologies, achieving a low insertion loss requires a corresponding compromise in filter steepness or selectivity.

In commercial telecommunications applications, it is often desirable to filter out the smallest possible pass-band using narrow-band filters to enable a fixed frequency spectrum to be divided into the largest possible number of frequency bands, thereby increasing the actual number of users capable of being fit in the fixed spectrum. With the dramatic rise in wireless communications, such filtering should provide high degrees of both selectivity (the ability to distinguish between signals separated by small frequency differences) and sensitivity (the ability to receive weak signals) in an increasingly hostile frequency spectrum. Of most particular importance is the frequency range from approximately 800-2,200 MHz. In the United States, the 800-900 MHz range is used for analog cellular communications. Personal communication services (PCS) are used in the 1,800 to 2,200 MHz range.

Microwave filters are generally built using two circuit building blocks: a plurality of resonators, which store energy very efficiently at one frequency, f₀; and couplings, which couple electromagnetic energy between the resonators to form multiple stages or poles. For example, a four-pole filter may include four resonators and five couplings between the signal input, resonators and signal output. The strength of a given coupling is determined by its reactance (i.e., inductance and/or capacitance). The relative strengths of the couplings determine the filter shape, and the topology of the couplings determines whether the filter performs a band-pass or a band-stop function. The resonant frequency f₀ is largely determined by the inductance and capacitance of the respective resonator. For conventional filter designs, the frequency at which the filter is active is determined by the resonant frequencies of the resonators that make up the filter. Each resonator must have very low internal resistance to enable the response of the filter to be sharp and highly selective for the reasons discussed above. This requirement for low resistance tends to drive the size and cost of the resonators for a given technology. Microwave filters typically have multiple resonant frequencies, which allows microwave filters to be operated in different modes. These resonant frequencies include the fundamental frequency f₀ and multiples of the fundamental frequency f₀ (e.g., 2 f₀, 3 f₀, etc.) or multiples of a factor of the fundamental frequency f₀ (e.g., 2 f₀/n 3 f₀/n etc.).

Historically, filters have been fabricated using normal; that is, non-superconducting conductors. These conductors have inherent lossiness, and as a result, the circuits formed from them have varying degrees of loss. For resonant circuits, the loss is particularly critical. The quality factor (Q) of a device is a measure of its power dissipation or lossiness. For example, a resonator with a higher Q has less loss. Resonant circuits fabricated from normal metals in a microstrip or stripline configuration typically have Q's at best on the order of four hundred. With the discovery of high temperature superconductivity in 1986, attempts have been made to fabricate electrical devices from high temperature superconductor (HTS) materials. The microwave properties of HTS's have improved substantially since their discovery. Epitaxial superconductor thin films are now routinely formed and commercially available.

Currently, there are numerous applications where microstrip narrow-band filters that are as small as possible are desired. This is particularly true for wireless applications where HTS technology is being used in order to obtain filters of small size with very high resonator Q's. The filters required are often quite complex with perhaps twelve or more resonators along with some cross couplings. Yet the available size of usable substrates is generally limited. For example, the wafers available for HTS filters usually have a maximum size of only two or three inches. Hence, means for achieving filters as small as possible, while preserving high-quality performance are very desirable. In the case of narrow-band microstrip filters (e.g., bandwidths of the order of 2 percent, but more especially 1 percent or less), this size problem can become quite severe.

The factors that drive the size of these kinds of filters are varied. The filter size will generally increase if: the center frequency of the filter is decreased, the insertion loss target is decreased, the number of resonators required is increased, the power handling requirements (compression, intermodulation) requirements are increased, or if the stray coupling between non-nearest neighboring resonators is too large to be ignored. Any of these may lead a filter to be unrealizable due to the constraints imposed by finite, small substrate size.

In order to preserve the high-quality performance of a filter, it is desirable to minimize as much as possible the peak current densities within the structure of the filter. As discussed in U.S. Pat. No. 6,026,311, the peak current densities within a filter structure could be reduced by increasing the width of the microstrip lines and gaps between the lines relative to the thickness of the substrate. That is, wider microstrip lines could be used in the regions of the filter structure where high current is anticipated in order to minimize the current density within these regions, thereby increasing the power handling capability of the resulting filter. However, the relatively high current flowing through the microstrips creates a relatively large electromagnetic field that interferes with surrounding structures. Thus, in the case where the filter has multiple resonators, box-like structures may be placed around the respective resonators in order to prevent the electrical fields generated at each of the resonators from interfering from each other. These box-like structures, however, add to the size and cost of the filter.

In addition to size and loss considerations, of particular interest to the present inventions is the minimization of intermodulation distortion (IMD), which has become increasingly important in microwave and RF amplifier design. IMD is an undesirable phenomenon that occurs when two or more signals of different frequencies are present at the input of a non-linear device, thereby generating spurious emissions at frequencies different from the desired harmonic frequencies of the filter. The frequencies of the intermodulation products are mathematically related to the frequencies of the original input signals, and can be computed by the equation: mf₁±nf₂, where f₁ is the frequency of the first signal, f₂ is the frequency of the second signal, and m, n=0, 1, 2, 3, . . . . Intermodulation products are generated at various orders, with the order of a distortion product given by the sum of m+n. Conventional filter design techniques dictate that operating a filter at higher order modes (i.e., a mode corresponding to the second resonant frequency from the fundamental frequency f₀ or higher) is impractical due to crowding of the higher order intermodulation modes.

There, thus, remains a need to provide a filter having a smaller size, while having minimal unwanted mode activity and achieving very high unloaded Q's.

### SUMMARY OF THE INVENTION

In accordance with the present inventions, a monolithic filter comprise a substrate (e.g., one composed of a dielectric material), and one or more resonator structures (which may be planar in nature) formed on a planar side of the substrate. In one embodiment, the filter takes the form of a microstrip filter, and thus, includes a continuous ground plane disposed on the other planar side of the substrate. Each of the resonator structure(s) has a resonant frequency, e.g., in the microwave range (e.g., in the range of 800-2,200 MHz). Each resonator structure comprises a folded transmission line (e.g., a spiral-in, spiral-out configuration) that is patterned to form a plurality of adjacent line segments and a plurality of gaps disposed between the adjacent line segments. In one embodiment, the folded transmission line is composed of a high temperature superconductor (HTS) material. The filter further comprises an input terminal coupled to one end of the one or more resonator structures, and an output terminal connected to another end of the one or more resonator structures. The input terminal and output terminal may be coupled to the resonator structure(s) such that the filter can be operated as a narrowband filter.

The ratio of a sum of an average width of the adjacent lines and an average width of the gaps to a thickness of the substrate is equal to or less than 0.50. In one embodiment, the ratio is equal to or less than 0.30. In another embodiment, the ratio is equal to or less than 0.20. In still another embodiment, the ratio is equal to or less than 0.10. Each of the resonator structures may have any shape, e.g., rectangular or circular. In yet another embodiment, each resonator structure has a nominal linear electrical length of a full wavelength at the resonant frequency of the respective resonator structure. If the filter comprises multiple resonator structures, they may be coupled to each other in series. In this case, each of the resonator structures may have a nominal linear electrical length of a full wavelength at the resonant frequency of the respective resonator structure, and the input terminal and output terminal may be coupled to the resonator structures such that the filter can be operated in a higher order mode.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a plan view of a prior art spiral-in, spiral-out resonator filter;

FIG. 2 is a cross-sectional view of the prior art spiral-in, spiral-out resonator of FIG. 1, taken along the line 2-2;

FIG. 3 is a plan view of a basic spiral-in, spiral-out resonator structure constructed in accordance with the present inventions;

FIG. 4 is a cross-sectional view of the spiral-in, spiral-out resonator structure of FIG. 3, taken along the line 4-4;

FIG. 5 is a magnified view of the spiral-in, spiral-out resonator structure of FIG. 4, taken along the line 5-5;

FIG. 6 is a plan view of the resonator constructed in accordance with the present inventions, wherein the resonator uses two of the spiral-in, spiral-out resonator structures illustrated in FIG. 3;

FIG. 7 is a plan view of the two-wavelength resonator of FIG. 6 as compared to a prior art two-wavelength spiral-in, spiral out resonator;

FIG. 8 is a plan view of another resonator constructed in accordance with the present inventions, wherein the resonator uses two circular spiral-in, spiral-out resonator structures;

FIG. 9 is a plan view of a single-resonator filter constructed in accordance with the present inventions, wherein the filter uses eight of the resonators illustrated in FIG. 6 coupled to each other to form a single higher-order resonator;

FIG. 10 is a plot of the computed frequency response of the filter of FIG. 9;

FIG. 11 is a plot showing the normalized intermodulation distortion plotted against normalized input power for two types of resonators constructed in accordance with the present inventions, wherein one type has mitered/rounded corners and the second type has non-mitered/rounded corners;

FIG. 12 is a plan view of a multi-resonator filter constructed in accordance with the present inventions, wherein the filter uses four of the resonators illustrated in FIG. 6;

FIG. 13 is a plot of the computed frequency response of the filter of FIG. 12;

FIG. 14 is a plan view of a multi-resonator filter constructed in accordance with the present inventions, wherein filter uses two of the resonators illustrated in FIG. 6;

FIG. 15 is a plot of the computed frequency response of the filter of FIG. 14;

FIG. 16 is a plan view of a multi-resonator filter constructed in accordance with the present inventions, wherein the filter uses ten of the resonators illustrated in FIG. 6;

FIG. 17 is a plan view of a multi-resonator filter that uses eight two-wavelength resonators constructed in accordance with the present inventions; and

FIG. 18 is a plot of the computed frequency response of the filter of FIG. 17.

### DETAILED DESCRIPTION OF THE EMBODIMENTS

In contrast to the conventional approach that maximizes the widths of resonator lines to decrease the peak current density within the resonator, it has been discovered that decreasing the resonator lines and gaps relative to the filter substrate results in a relatively small filter exhibiting a high quality factor (Q) and inherent power handling capabilities. It has also been discovered that, contrary to conventional thinking, higher order filters that operate at a higher order even mode do not readily excite neighboring modes resulting in a very clean broadband response with a much wider band free of re-entrant moding, and further reduces the nonlinear effects due to the use of high temperature superconductor (HTS) material.

In the illustrated embodiments of the radio frequency (RF) filters described below, full-wavelength (λ) spiral-in, spiral-out resonators are used due to their ability to reduce the peak current near the edges of the resonator lines. The filters are used as band-pass filter having a pass band within a desired frequency range, e.g., 800-900 MHz or 1,800-2,220 MHz. In a typical scenario, the RF filters are placed within the front-end of a receiver (not shown) behind a wide pass band filter that rejects the energy outside of the desired frequency range.

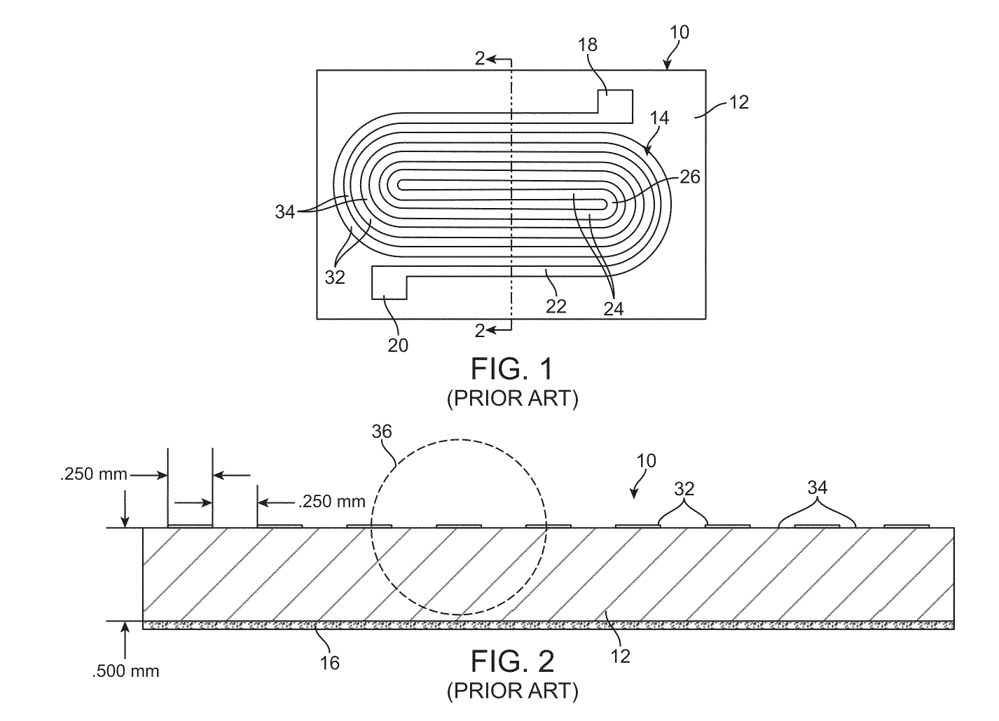

As shown in FIGS. 1 and 2, a conventional filter 10 will first be described. The conventional filter structure 10 comprises a substrate 12 and a spiral-in, spiral-out (SISO) resonator structure 14 patterned on one planar side (top side) of the substrate 12.

For ease of manufacturing, the resonator structure 14 may be monolithically formed onto the substrate 12 using conventional techniques, such as photolithography. In the illustrated embodiment, the resonator structure 14 may be composed of an HIS material, such as an epitaxial thin film Thallium Barium Calcium Cuprate (TBCCO) or Yttrium Barium Cuprate (YBCO). Alternatively, the resonator structure 14 may be composed of superconductors such as Magnesium Diboride (MgB2), Niobium, or other superconductor whose transition temperature is less than 77K as these allow the designer to make use of substrates that are incompatible with HTS materials. Alternatively, the resonator structure 14 may be composed of a normal metal, such as aluminum, silver or copper even though the increased resistive loss in these materials may limit the applicability of the invention.

The substrate 12 may be composed of a dielectric material, such as LaAIO₃, Magnesium Oxide (MgO), sapphire, or polyimide. In the illustrated embodiment, the conventional filter 10 has a microstrip architecture, and thus, further comprises a continuous ground plane 16 disposed on the other planar side (bottom side) of the substrate 12 opposite to the resonator structure 14. Alternatively, the conventional filter 10 has a stripline architecture, in which case, the filter 10 may instead comprise another dielectric substrate (not shown), with the resonator structure 14 being sandwiched between the respective dielectric substrates. The filter 10 further comprises an input terminal (pad) 18 and an output terminal (pad) 20 coupled to the resonator structure 14 in a manner that configures the filter 10 to have narrowband characteristics.

The resonator structure 14 includes a folded transmission line 22 that is patterned to form a SISO structure. Generally, a SISO structure is a conductor that is folded over onto itself to form two parallel lines 24 that are connected to each other by a single 180° bend 26. The two lines 24 are then spiraled around the bend 26 together in the same direction, with the end of one line 24 exiting the structure in one direction to couple to the input terminal 18, and the end of the other line 24 exiting the structure in the opposite direction to couple to the output terminal 20. In other words, one end of the transmission line 22 has a plurality of turns of lefthandedness, which when combined, turn through at least 360° and the other end of the transmission line 22 has a plurality of turns of righthandedness, which when combined, turn through at least 360°. At least one turn of lefthandedness is disposed between at least two turns of righthandedness, and at least one turn of righthandedness is disposed between at least two turns of lefthandedness. Further details describing various types of these SISO resonator structures are disclosed in U.S. Pat. No. 6,026,311, which is expressly incorporated herein by reference.

As shown in FIG. 2, the transmission line 22 forms a plurality of line segments 32 and a plurality of gaps or spaces 34 between the line segments 32. The transmission line 22 generates an electromagnetic field that has a field of influence 36 that tends to be of the same order as the widths of the line segments 32 and the gaps 34 between the line segments 32. Notably, as a result of the SISO architecture, the currents in adjacent line segments 32 are unidirectional, which tends to reduce the peak magnitude of the current near the edges of the transmission line 22 within the resonator structure 14.

In the embodiment illustrated in FIG. 2, the ratio of the sum of the average width of the line segments 32 (in this case, 0.250 mm) and the average width of the gaps 34 (in this case, 0.250 mm) to the thickness 38 of the substrate 12 (in this case, 0.500 mm) is relatively great (in this case, 1), which generates an electromagnetic field that extends far beyond the resonator structure 14 itself, thereby resulting in a relatively large field of influence 36 between the resonator structure 14 and the ground plane 16 disposed on the substrate 12 below, and any metallic elements, including electrically grounded lids, above the substrate 12.

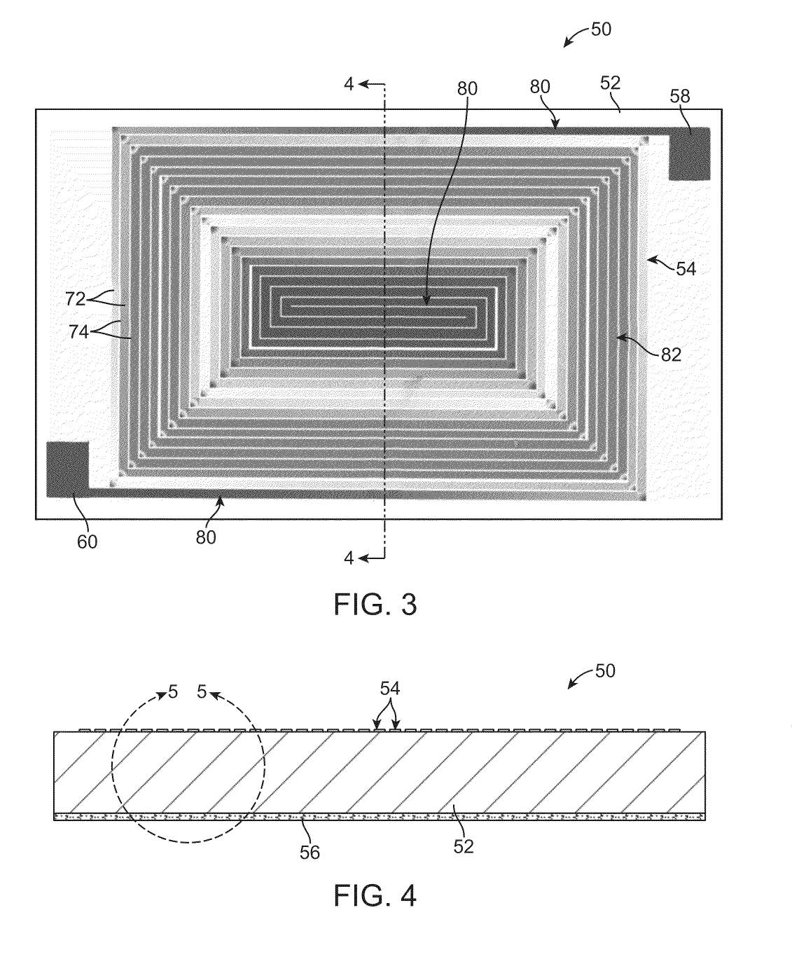

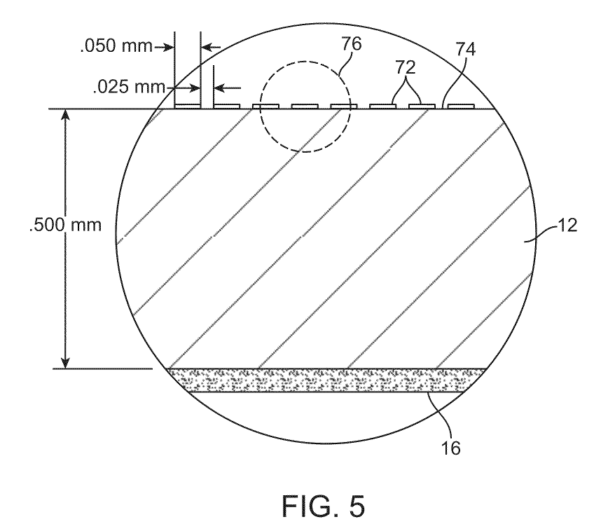

As shown in FIGS. 3 and 4, a filter 50 constructed in accordance with an embodiment of the present inventions will now be described. Like the conventional filter structure 10, the filter 50 comprises a substrate 52, a spiral-in, spiral-out (SISO) resonator structure 54 patterned on one planar side (top side) of the substrate 52, a continuous ground plane 56 disposed on the other planar side (bottom side) of the substrate 52 opposite the resonator structure 54, and an input terminal (pad) 58 and an output terminal (pad) 60 coupled to the resonator structure 54 in a manner that configures the filter 50 to have narrowband characteristics. Like the resonator structure 14, the resonator structure 54 includes a folded transmission line 62 that is patterned to form a SISO structure, and forms a plurality of line segments 72 and intervening gaps 74 between the line segments 72.

Significantly, unlike the conventional resonator structure 14, the ratio of the sum of the average width of the line segments 72 (in this case, 0.050 mm) and the average width of the gaps 74 (in this case, 0.025 mm) between the line segments 72 to the thickness of the substrate 52 (in this case, 0.500 mm) is relatively small. Although this ratio is 0.15 in the illustrated embodiment, the ratio may be equal to or less than 0.50, preferably equal to or less than 0.30, and more preferably equal or less than 0.20. Although the widths of the line segments 72 and intervening gaps 74 are uniform, it should be noted that the widths of the line segments 72, as well as the widths of the gaps 74, may be non-uniform, as long as the ratio of widths and gaps to substrate thickness remains relatively small.

Thus, having such a low ratio results in the generation of an electromagnetic field that does not extend far beyond the resonator structure 14, thereby resulting in a relatively small field of influence 76 between the resonator structure 14 and the ground plane 56 disposed on the substrate 52 below, and any metallic elements, including the electrically grounded lid, above the substrate 52. This allows the physically planar resonator structure 54 to exhibit a three-dimensional complexion (i.e., a donut or toroid-shaped electromagnetic field) without coupling to the lossy metallic elements surrounding the resonator structure 54, thereby giving rise to a more efficient energy storage. That is, the resonator structure 54 is more energy efficient due to the minimal interaction between the resonator structure 54 and the outside world.

Direct capacitive coupling to the resonator structure 54 via the input terminal 58 and output terminal 60 can be achieved at the high-voltage ends of the resonator structure 54. The lengths of the high-voltage ends of the resonator structure 54 may be adjusted according to the external loading, such that the current nodes occur at the geometric center of the resonator structure 54, giving rise to edge-current reduction at the edges of the transmission line 62 as well as the edges of the resonator structure 54, as described in U.S. Pat. No. 6,026,311, which is expressly incorporated herein by reference.

The current density of the resonator structure 54 was computed using the full-wave planar program Sonnet with cell sizes equal to the width of the line segments and gaps therebetween. Sonnet uses red for the most intense current densities, while, as the current weakens, the colors vary with the rainbow down to blue for the weakest current densities. As seen in grayscale, the corresponding current densities will range from a fairly dark gray for the most intense current densities down to a very light gray or white for the mid-range current densities, on to nearly black for the very low current densities.

As shown in FIG. 3, a relatively low current density region 80 is located in the center of the resonator structure 54 and at the ends of the transmission line 62, reflecting the three current nodes for a full-wave length structure (i.e., for a full-wavelength transmission line, the first zero-current node will be at the beginning of the transmission line, the second zero-current node will be in the middle of the transmission line, and the third zero-current node will be at the end of the transmission line), and a relatively high current density region 82 is located at the periphery of the resonator structure 54, reflecting the two current peaks for a full-wave length structure (i.e., for a full-wavelength transmission line, the first current peak will be at the half-way point of the spiral-in portion of the transmission line, and the second current peak will be at the half-way point of the spiral-out portion of the transmission line).

The single resonator structures constructed in accordance with the present inventions can be used as building blocks for the design of higher order resonators that are much smaller than and/or may be operated at significantly lower frequencies than, similar conventional monolithic resonators. These resonators can be used in filters that are designed to operate the resonator at higher resonant modes. These higher order modes do not readily excite neighboring modes, resulting in a very clean broadband response with no-entrant moding and no signs of spurious modes out to three times the preferred resonance. Such resonators may be operated in any full wave mode operation, (nλ, where n is any integer) (e.g., second (λ), fourth (2λ), sixth (3λ), etc.). These higher order resonators also have higher power handling capabilities. The resonators may be designed around the desired higher order mode. That is, the resonator may be tuned at the selected higher order mode, such that very little energy will couple into the other modes.

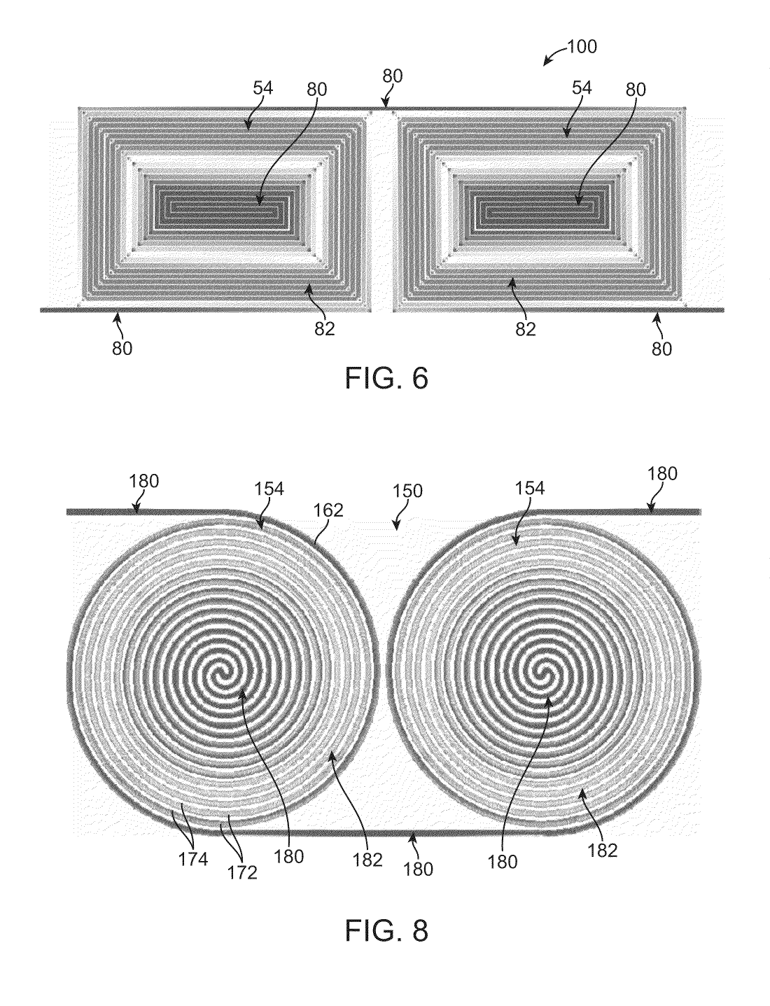

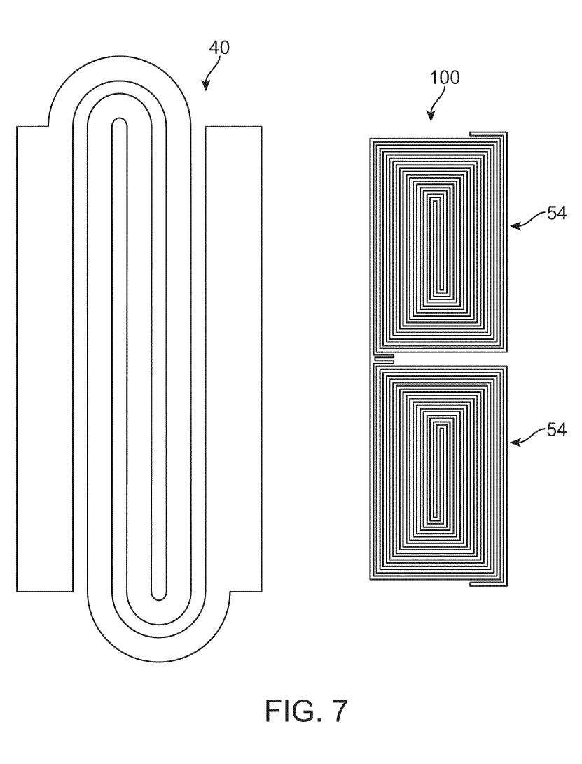

For example, as shown in FIG. 6, two of the basic resonator structures 54 are connected together in series to form a two-wavelength (2λ) resonator 100. As a result of the relatively small ratio of the widths of the transmission lines and gaps of the basic resonator structures 54 to the thickness of the substrate, more of the electromagnetic field is confined nearer to the surface of the substrate, such that the far-field effects of the basic resonator structures 54 are substantially reduced, allowing closer proximity of the resonator structures 54, and enabling smaller higher-order filters.

Direct capacitive coupling to the resonator structures 54 may be achieved at or near the central current node, such that other modes of the resonator structures 54 are not easily excited, since the local voltage at the central capacitive coupling node is nearly zero when the resonator would be resonating in any of its nλ/2 modes. The modeling suggests that the nearby (n±1]λ modes could be excited though the filter is often mistuned at those frequencies and the energy coupled in may in reality be quite small. In comparison to the conventional two wavelength (2λ) resonator 40 illustrated in FIG. 8, which is designed to operate at the same frequency, the size of foot print of the two wavelength (2λ) resonator 100 is considerably smaller.

As shown in FIG. 6, the relatively low current density region 80 is located in the center of each resonator structure 54, at the ends of the transmission line 62, and at the center of the transmission line 62 between the resonator structures 54, reflecting the five current nodes for a two-wave length structure, and two relatively high current density regions 82 are located at the peripheries of the resonator structures 54, reflecting the four current peaks for a two-wave length structure.

It can be appreciated that the reduced size of the higher-order resonator 100 results in lower costs due to the reduced substrate area and smaller microwave packaging, and gives rise to the possibility that normal metal (non-HTS) filters might be made small enough for use in cellular handset type applications. For HTS applications, the smaller size of the filter can also dramatically reduce the overall cryogenic head load, enabling the use of smaller, less power-hungry cryogenic coolers. The enhanced length of the resonator (fourth mode or higher) helps to reduce some of the nonlinear effects in materials, such as HTS, by introducing multiple peaks along the length of the transmission line to reduce the peak current in the resonator. These higher order modes also radiate much less than do the lower modes, thereby allowing further reduction in the size of the filter. This is primarily due to the low ratio of the widths of the lines and gaps to the substrate thickness, since the electromagnetic fields to not extend very far away from the resonators and preferentially interact with other parts of the same resonators and not ground planes of neighboring resonators.

Although the basic resonator structures have been illustrated as being rectangular in shape, it should be appreciated that the basic resonator structures may have other shapes. For example, with reference to FIG. 8, two circular resonator structures 154 are connected together in series to form a two-wavelength (2λ) resonator 150. Like the basic resonator structures 54, each of the circular resonator structures 154 includes a folded transmission line 162 that is patterned to form a SISO structure, and forms a plurality of line segments 172 and intervening gaps 174 between the line segments 172. The ratio of the sum of the average width of the line segments 172 and the average width of the gaps 174 between the line segments 172 to the thickness of the substrate is relatively small. The current density of the resonator structures 154 was computed using the full-wave planar program Sonnet with cell sizes equal to the width of the line segments and gaps therebetween.

As shown in FIG. 8, a relatively low current density region 180 is located in the center of each resonator structure 154, at the ends of the transmission line 162, and at the center of the transmission line 162 between the resonator structures 154, reflecting the five current nodes for a two-wave length structure, and two relatively high current density regions 182 are located at the peripheries of the resonator structures 54, reflecting the four current peaks for a two-wave length structure.

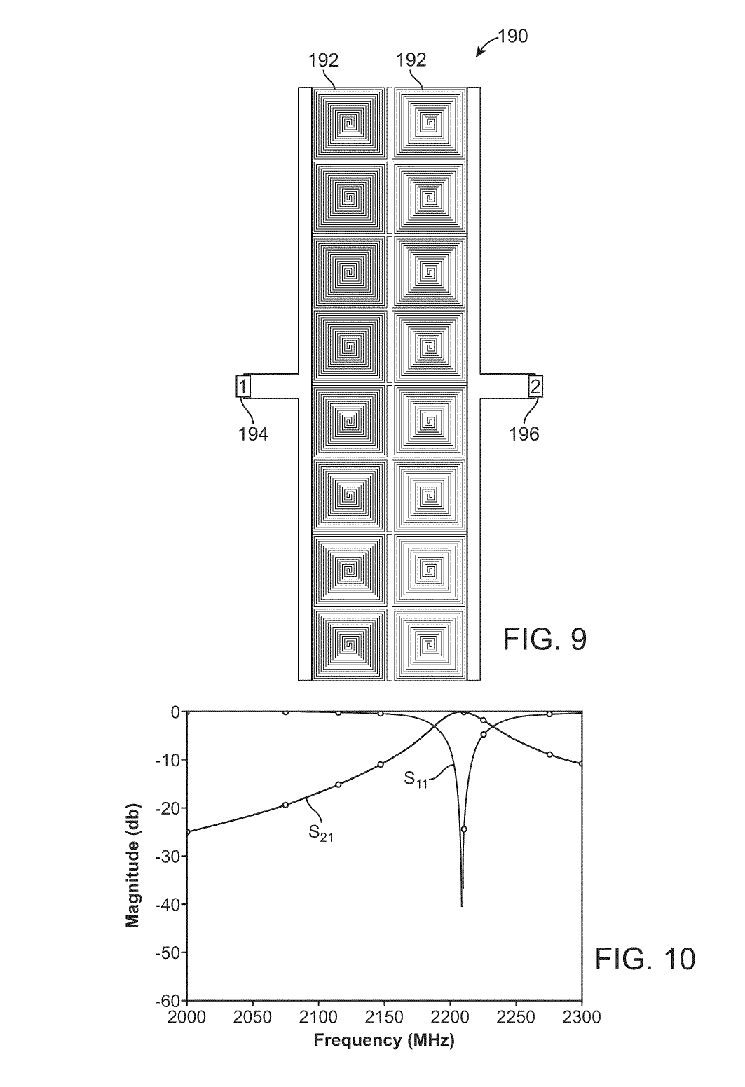

It should be appreciated that the resonator structures disclosed herein and be combined to provide resonators that can be operated at wavelengths higher than 2λ in order to increase their power handling capabilities when used for signal transmission purposes. For example, with reference to FIG. 9, a single resonator 190 includes eight basic resonator structures 192 that are connected together between an input port 194 and an output port 196 in series to provide an improvement in power handling of 9 dB (i.e., three successive doublings of resonators (2³)). Each of the resonator structures 192 is similar to the previously described resonator structure 54 in that the widths of the line segments and intervening gaps are relatively small relative to the thickness of the substrate. The resulting resonator 190 has an effective wavelength of 8λ that can be operated in many of the nλ modes. The computed frequency response (S₁₁ and S₂₁) of the resonator 190 is shown in FIG. 10. Further details discussing techniques in increasing the power handling of filters using multiple basic resonator structures are disclosed in U.S. patent application Ser. No. 12/118,533, entitled “Zig-Zag Array Resonators for Relatively High-Power HTS Applications,” which is expressly incorporated herein by reference.

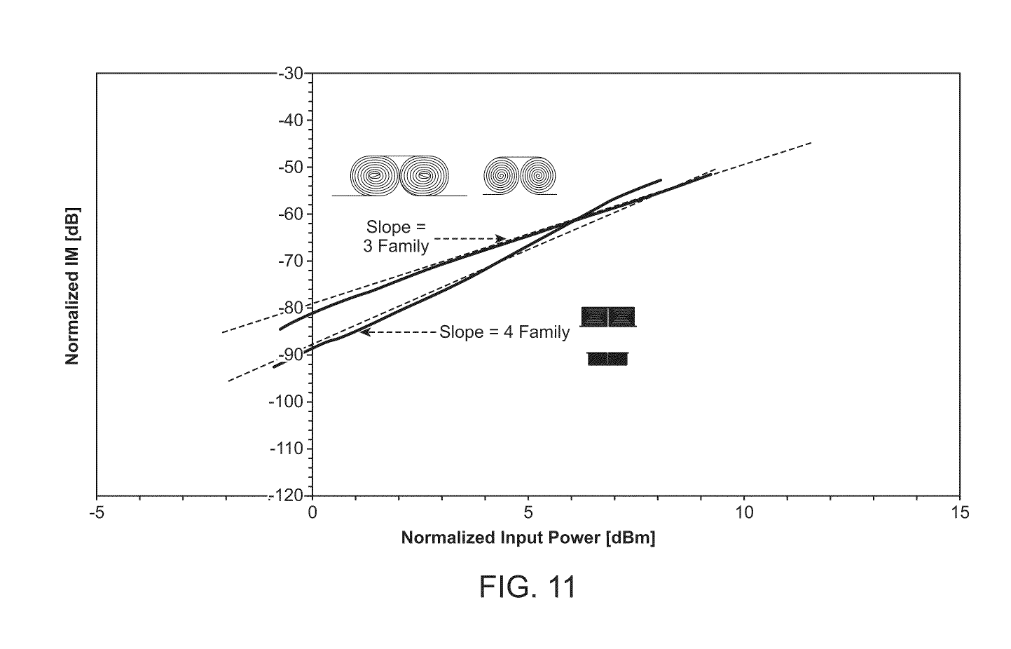

The corners of the resonators described herein can be shaped in order to effect a desired IMD slope. For example, with reference to FIG. 11, the IMD for a resonator with rounded/mitered or chamfered corners and the IMD for a resonator with squared corners were measured against a normalized input power. As shown, the resonator with the rounded corners exhibited an IMD slope of 3, whereas the resonator with squared corners exhibited an IMD slope of 4. Thus, the corners of the resonators may be advantageously shaped depending upon whether the filter is to be operated at relatively low power levels or relatively high power levels.

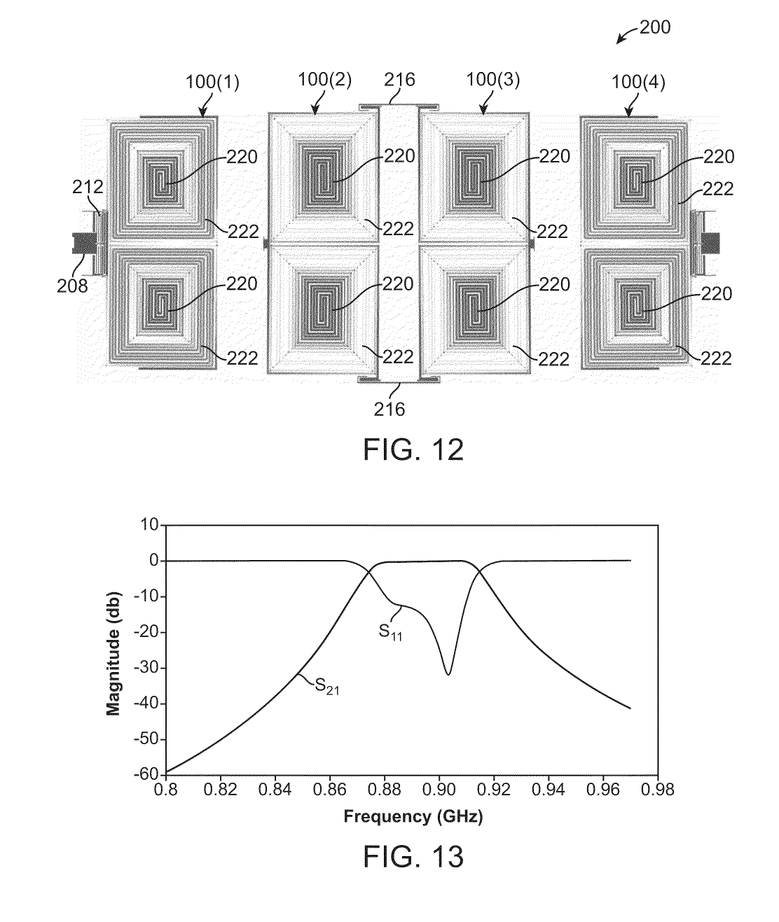

The previously described resonators may be coupled together to form a multi-resonator filter. For example, with reference to FIG. 12, a band-pass filter 200 comprises four two-wavelength (2λ) resonators 100, an input terminal 208 coupled to the first resonator 100(1) via a capacitive coupling 212, and an output terminal 210 coupled to the fourth resonator 100(4) via a capacitive coupling 214. The second resonator 100(2) and third resonator 100(3) are coupled to together at their tops and bottoms via conductors 216 as a means to enhance the native coupling between the second resonator 100(2) and third resonator 100(3). The current density of the resonators 100 was computed using the full-wave planar program Sonnet with cell sizes equal to the width of the line segments and gaps therebetween. As shown in FIG. 12, relatively low current density regions 220 are located in the centers of each resonator 100 and at the ends of the transmission line, and relatively high current density regions 222 are located at the periphery of the second and third resonators 100(2), 100(3). The computed frequency response (S₁₁ and S₂₁) of the resonator filter 200 is shown in FIG. 13.

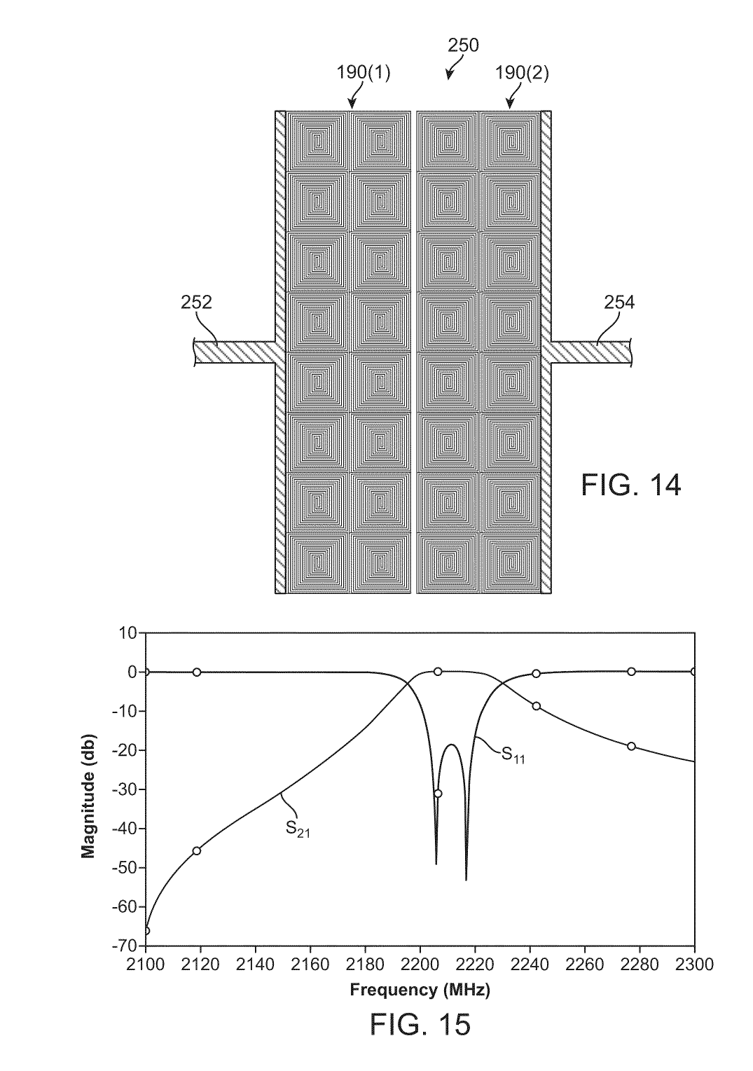

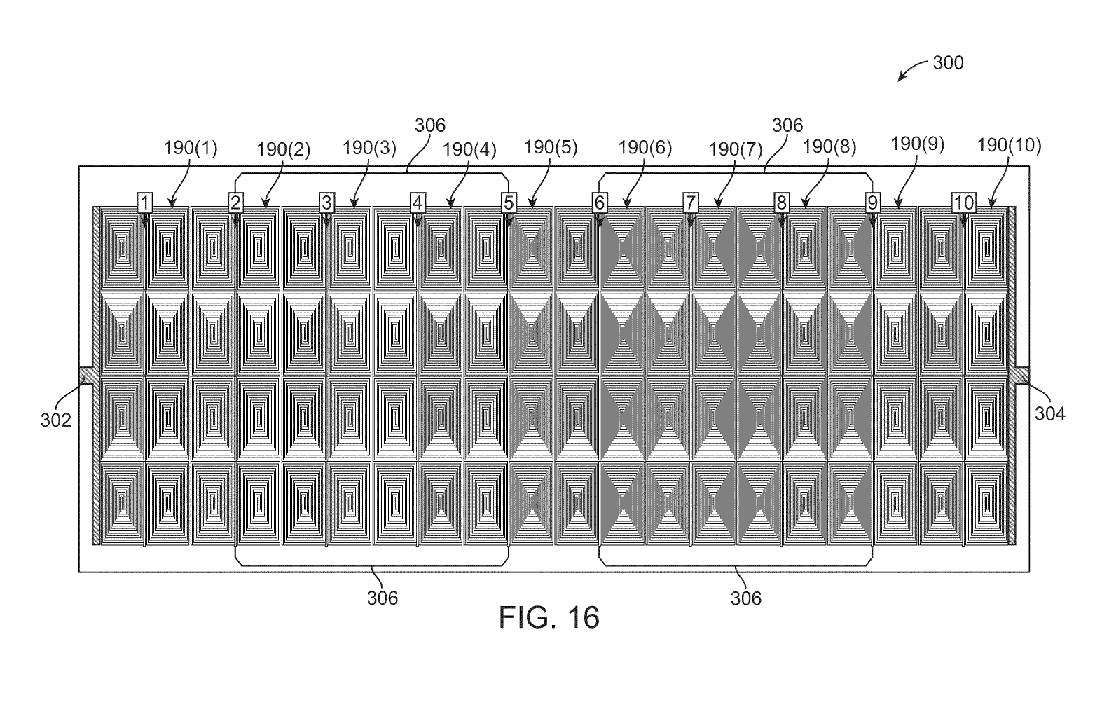

As another example, with reference to FIG. 14, a band-pass filter 250 comprises two sixteen-wavelength (16λ) resonators 190, an input terminal 252 coupled to the first resonator 190(1), and an output terminal 254 coupled to the second resonator 190(2). The computed frequency response (S₁₁ and S₂₁) of the resonator filter 250 is shown in FIG. 15. As still another example with reference to FIG. 16, a band-pass filter 300 comprises ten sixteen-wavelength (16λ) resonators 190, an input terminal 302 coupled to the first resonator 190(1), and an output terminal 304 coupled to the tenth resonator 190(10). The second resonator 100(2) and fifth resonator 100(5) are coupled to together at their tops and bottoms via cross-couplings 306, and the sixth resonator 100(6) and ninth resonator 100(9) are coupled to together at their tops and bottoms via cross-couplings 306, thereby creating transmission zeroes in the near stop-band, going from a Chebyshev-like response to a quasi-elliptical response. This is done to increase the near-band selectivity of the filter (slope of the rejection) at the expense of rejection further away from the pass band.

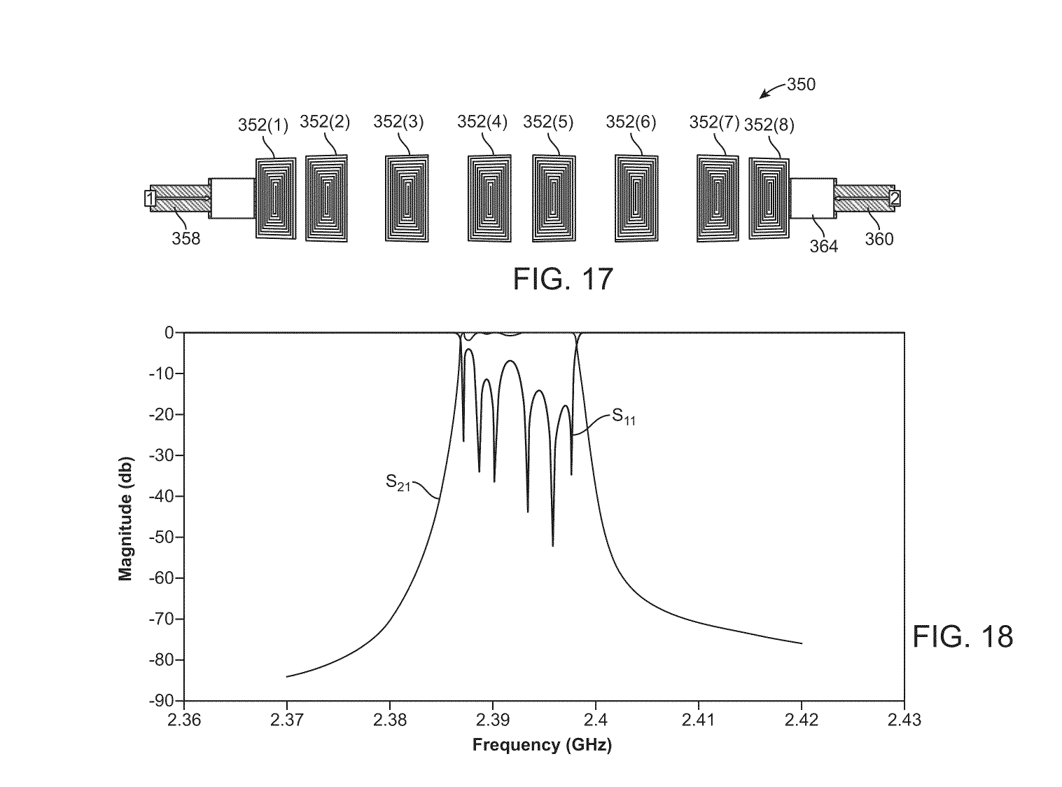

As still another example, with reference to FIG. 17, a band-pass filter 350 comprises eight two-wavelength (2λ) resonators 352, an input terminal 358 coupled to the first resonator 352(1) via a capacitive coupling 362, and an output terminal 360 coupled to the eight resonator 352(8) via a capacitive coupling 364. Each of the resonators 352 is identical to the resonator 100 illustrated in FIG. 6, with the exception that the line width of the line segments is 0.01 mm, and the width of the gaps between the line segments is 0.005 mm. Thus, the ratio of sum of the average width of the line segments and the average width of the gaps to the thickness of the substrate is 0.03. The computed frequency response (S₁₁ and S₂₁) of the resonator filter 350 is shown in FIG. 18.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A monolithic filter, comprising:
a substrate;
one or more resonator structures formed on a planar side of the substrate, each of the one or more resonator structures having a resonant frequency and comprising a folded transmission line that is patterned to form a plurality of adjacent line segments and a plurality of gaps disposed between the adjacent line segments, wherein the ratio of a sum of an average width of the adjacent lines and an average width of the gaps to a thickness of the substrate is equal to or less than 0.50;
an input terminal coupled to one end of the one or more resonator structures; and
an output terminal connected to another end of the one or more resonator structures.

2. The filter of claim 1, wherein the input terminal and output terminal are coupled to the one or more resonator structures such that the filter can be operated as a narrowband filter.

3. The filter of claim 1, wherein the folded transmission line has a spiral-in, spiral-out configuration.

4. The filter of claim 1, wherein the ratio is equal to or less than 0.30.

5. The filter of claim 1, wherein the ratio is equal to or less than 0.20.

6. The filter of claim 1, wherein the ratio is equal to or less than 0.10.

7. The filter of claim 1, wherein the substrate is composed of a dielectric material.

8. The filter of claim 7, further comprising an electrically conductive ground plane disposed on the other planar side of the substrate.

9. The filter of claim 1, wherein each of the one or more resonator structures is rectangular.

10. The filter of claim 1, wherein each of the one or more resonator structures is circular.

11. The filter of claim 1, wherein each of the one or more resonator structures is a planar structure.

12. The filter of claim 1, wherein the folded transmission line is composed of high temperature superconductor (HTS) material.

13. The filter of claim 1, wherein each of the one or more resonator structures has a nominal linear electrical length of a full wavelength at the resonant frequency of the respective resonator structure.

14. The filter of claim 1, wherein the one or more resonator structures comprises a plurality of resonator structures that are coupled to each other in series.

15. The filter of claim 14, wherein each of the resonator structures has a nominal linear electrical length of a full wavelength at the resonant frequency of the respective resonator structure, and the input terminal and output terminal are coupled to the resonator structures such that the filter can be operated in a higher order mode.

16. The filter of claim 1, wherein the resonant frequency is in the microwave range.

17. The filter of claim 16, wherein the resonant frequency is in the range of 800-2,200 MHz.
